(19) United States
(12) Patent Application Publication
(10) Pub. No.: US 2019/0136777 A1
(43) Pub. Date: May 9, 2019

(54) CONTROLLER FOR INTERNAL COMBUSTION ENGINE AND METHOD FOR CONTROLLING INTERNAL COMBUSTION ENGINE

(71) Applicant: TOYOTA JIDOSHA KABUSHIKI KAISHA, Toyota-shi (JP)

(72) Inventors: Hiroyuki TANAKA, Toyota-shi (JP); Yuki NOSE, Kasugai-shi (JP); Masaaki KOBAYASHI, Seto-shi (JP); Yoshiyuki SHOGENJI, Toyota-shi (JP); Eiji IKUTA, Obu-shi (JP); Misako BAN, Toyota-shi (JP)

(73) Assignee: TOYOTA JIDOSHA KABUSHIKI KAISHA, Toyota-shi (JP)

(21) Appl. No.: 16/157,784

(22) Filed: Oct. 11, 2018

(30) Foreign Application Priority Data
Nov. 9, 2017 (JP) 2017-216712

(51) Int. Cl. F02D 41/02; F01N 3/023; F02D 41/00; F02D 41/08; F01N 11/00

(52) U.S. Cl. CPC F02D 41/029; F01N 3/023; F02D 41/0085; F02D 41/08; F01N 2900/1606; F02D 2200/0802; F02D 2200/0812; F02D 2200/602; F01N 11/00

(57) ABSTRACT

A controller for an internal combustion engine includes processing circuitry. The processing circuitry is configured to execute a dither control process under a condition in which a request for executing a regeneration process of a filter is made. The processing circuitry is further configured to execute a fuel cutting process stopping fuel injection performed by fuel injection valves under a condition in which an accelerator operation amount is zero and a prohibition process prohibiting the fuel cutting process under a condition in which the dither control process is executed.

### BACKGROUND

The present disclosure relates to a controller for an internal combustion engine and a method for controlling an internal combustion engine.

For example, Japanese-Laid Open Patent Publication No. 2012-219732 describes a controller for an internal combustion engine that includes a filter capturing particulate matter from exhaust. The controller executes a filter temperature increase process for a filter regeneration process that removes clogging, that is, an excessive increase in the amount of particulate matter (PM) captured by the filter. More specifically, the controller performs the filter temperature increase process by executing cylinder-basis air-fuel ratio control (dither control). In dither control, some cylinders are set to a lean combustion cylinder, the air-fuel ratio of which is leaner than a stoichiometric air-fuel ratio, and the remaining cylinders are set to a rich combustion cylinder, the air-fuel ratio of which is richer than the stoichiometric air-fuel ratio.

Japanese-Laid Open Patent Publication No. 2007-177759 describes a known controller that executes a fuel cutting process.

Execution of the fuel cutting process decreases the temperature of gasses flowing into the filter. Thus, while the filter temperature increase process is executed for the filter regeneration process, if the fuel cutting process is executed, the temperature of the filter may be decreased to below temperatures at which PM is burnable. This may extend time needed in the filter regeneration process.

### SUMMARY

Multiple aspects of the present disclosure and the advantages are as follows.

1. In a controller for an internal combustion engine mounted on a vehicle, the internal combustion engine includes a filter configured to capture particulate matter in exhaust discharged from a plurality of cylinders and a plurality of fuel injection valves respectively arranged for the plurality of cylinders. The controller includes processing circuitry. The processing circuitry is configured to execute a dither control process operating the fuel injection valves so that at least one of the plurality of cylinders is a lean combustion cylinder having an air-fuel ratio that is leaner than a stoichiometric air-fuel ratio and at least a further one of the plurality of cylinders is a rich combustion cylinder having an air-fuel ratio that is richer than the stoichiometric air-fuel ratio under a condition in which a request for executing a regeneration process of the filter is made, a fuel cutting process stopping fuel injection performed by the fuel injection valves under a condition in which an accelerator operation amount is zero, and a prohibition process prohibiting the fuel cutting process under a condition in which the dither control process is executed.

In a method for controlling an internal combustion engine mounted on a vehicle, the internal combustion engine includes a filter configured to capture particulate matter in exhaust discharged from a plurality of cylinders and a plurality of fuel injection valves respectively arranged for the plurality of cylinders. The method includes executing a dither control process operating the fuel injection valves so that at least one of the plurality of cylinders is a lean combustion cylinder having an air-fuel ratio that is leaner than a stoichiometric air-fuel ratio and at least a further one of the plurality of cylinders is a rich combustion cylinder having an air-fuel ratio that is richer than the stoichiometric air-fuel ratio under a condition in which a request for executing a regeneration process of the filter is made, executing a fuel cutting process stopping fuel injection performed by the fuel injection valves under a condition in which an accelerator operation amount is zero, and executing a prohibition process prohibiting the fuel cutting process under a condition in which the dither control process is executed.

With the above configuration, under a condition in which the dither control process is executed, the fuel cutting process is prohibited. Thus, as compared to when the fuel cutting process is not prohibited, the filter is easily maintained at a high temperature. This avoids a situation extending the time needed to complete the filter regeneration process.

2. In the controller for an internal combustion engine according to the first aspect described above, the prohibition process includes a process prohibiting the fuel cutting process when the dither control process is executed and a temperature of the filter is increased from below a required temperature toward the required temperature. The required temperature is a temperature required by the regeneration process.

With the above configuration, when the temperature of the filter is increasing toward the required temperature, which is the temperature required by the regeneration process, the fuel cutting process is prohibited. Thus, as compared to when the fuel cutting process is not prohibited, the temperature of the filter quickly increases to the required temperature.

3. In the controller for an internal combustion engine according to the second aspect described above, the dither control process includes controlling the air-fuel ratio of each cylinder in a first period so that at least one of the plurality of cylinders is the lean combustion cylinder, in which the air-fuel ratio is leaner than the stoichiometric air-fuel ratio, and at least a further one of the plurality of cylinders is the rich combustion cylinder, in which the air-fuel ratio is richer than the stoichiometric air-fuel ratio, controlling an average value of exhaust air-fuel ratios to a target air-fuel ratio in a second period including the first period, and under a condition in which the temperature of the filter reaches the required temperature, setting the target air-fuel ratio to be leaner than before the temperature of the filter reaches the required temperature. The prohibition process includes a process prohibiting the fuel cutting process when the target air-fuel ratio is set to be lean after the temperature of the filter reaches the required temperature.

With the above configuration, after the temperature of the filter reaches the required temperature, which is the temperature required by the regeneration control, the target air-fuel ratio is set to be lean. This increases the amount of oxygen flowing into the filter and ultimately supplies the filter with oxygen sufficient to burn the particulate matter. Additionally, with the above configuration, the fuel cutting process is also prohibited when the process for setting the target air-fuel ratio to further lean is executed. Execution of the fuel cutting process allows a large amount of oxygen to be supplied to the filter. However, if the temperature of the filter decreases, the particulate matter cannot be burned. Thus, when a large amount of particulate matter exists in the filter, if the fuel cutting process is executed, a large portion of the particulate matter may remain after the temperature of the filter is decreased. In this case, the temperature of the filter again needs to be increased. In this regard, with the above configuration, when the target air-fuel ratio is set to be lean, the fuel cutting process is prohibited. Thus, the regeneration process is quickly completed.

4. In the controller for an internal combustion engine according to any one of the first to third aspects described above, the processing circuitry is configured to execute the dither control process when an execution instruction signal of a regeneration process of the filter is input to the controller from outside the controller to service the filter.

With the above configuration, when the execution instruction signal of the filter regeneration process is input to the controller to service the filter, the dither control process is executed in accordance with the execution request of the regeneration process. Thus, as compared to normal operation performed by the user, the average value of exhaust air-fuel ratios is easily controlled to be leaner than the stoichiometric air-fuel ratio. Additionally, increases in variations of rotation of the crankshaft are easily allowed. Thus, the absolute value of a difference between the air-fuel ratio of the rich combustion cylinder and the air-fuel ratio of the lean combustion cylinder is easily increased.

5. In the controller for an internal combustion engine according to the fourth aspect, the processing circuitry is configured to execute a notification process providing notification for a user by operating a notification device when an amount of the particulate matter is greater than or equal to a specified amount.

With the above configuration, when the amount of the particulate matter is greater than or equal to the specified amount, the notification process is executed. This prompts the user to have service at a service shop.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagram showing one embodiment of an internal combustion engine and a controller for the internal combustion engine;

FIG. 2 is a block diagram showing some of the processes executed by the controller shown in FIG. 1;

FIG. 3 is a flowchart showing the procedures of a request value outputting process executed by the controller shown in FIG. 1; and

FIG. 4 is a time chart showing the effect of the controller shown in FIG. 1.

### DETAILED DESCRIPTION

One embodiment of a controller for an internal combustion engine will now be described with reference to the drawings.

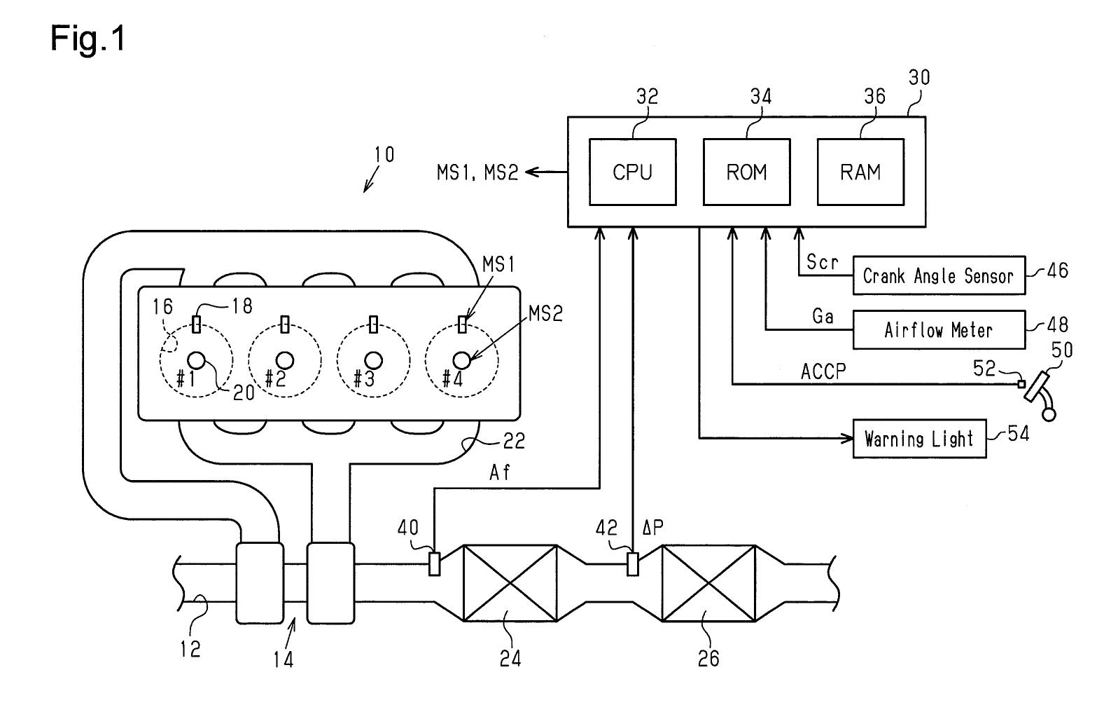

An internal combustion engine 10 shown in FIG. 1 is mounted on a vehicle. In the internal combustion engine 10, air drawn from an intake passage 12 flows through a supercharger 14 into combustion chambers 16 of cylinders #1 to #4. Each of the cylinders #1 to #4 includes a fuel injection valve 18 injecting fuel and an ignition device 20 producing spark discharge. In the combustion chambers 16, a mixture of air and fuel is burned. The burned mixture is discharged to an exhaust passage 22 as exhaust. A three-way catalyst 24 capable of storing oxygen is arranged in the exhaust passage 22 at the downstream side of the supercharger 14. Additionally, a gasoline particulate filter (GPF) 26 is arranged in the exhaust passage 22 at the downstream side of the three-way catalyst 24.

A controller 30 controls the internal combustion engine 10. More specifically, the controller 30 operates operating portions such as the fuel injection valves 18 and the ignition devices 20 to control the control amounts (e.g., torque, exhaust components) of the internal combustion engine 10. In this operation, the controller 30 refers to an air-fuel ratio Af detected by an air-fuel ratio sensor 40 arranged at the upstream side of the three-way catalyst 24 and a differential pressure ΔP of the atmospheric pressure and pressure of the upstream side of the GPF 26 detected by a differential pressure sensor 42. The differential pressure ΔP corresponds to a difference in pressure between the upstream side and the downstream side of the GPF 26 and has a positive value when the upstream-side pressure is greater than the atmospheric pressure. The controller 30 also refers to an output signal Scr of a crank angle sensor 46, an intake air amount Ga detected by an airflow meter 48, and a depression amount (accelerator operation amount ACCP) of an accelerator pedal 50 detected by an acceleration sensor 52. The controller 30 includes a CPU 32, a ROM 34, and a RAM 36 and controls the control amounts described above by running programs stored in the ROM 34 with the CPU 32.

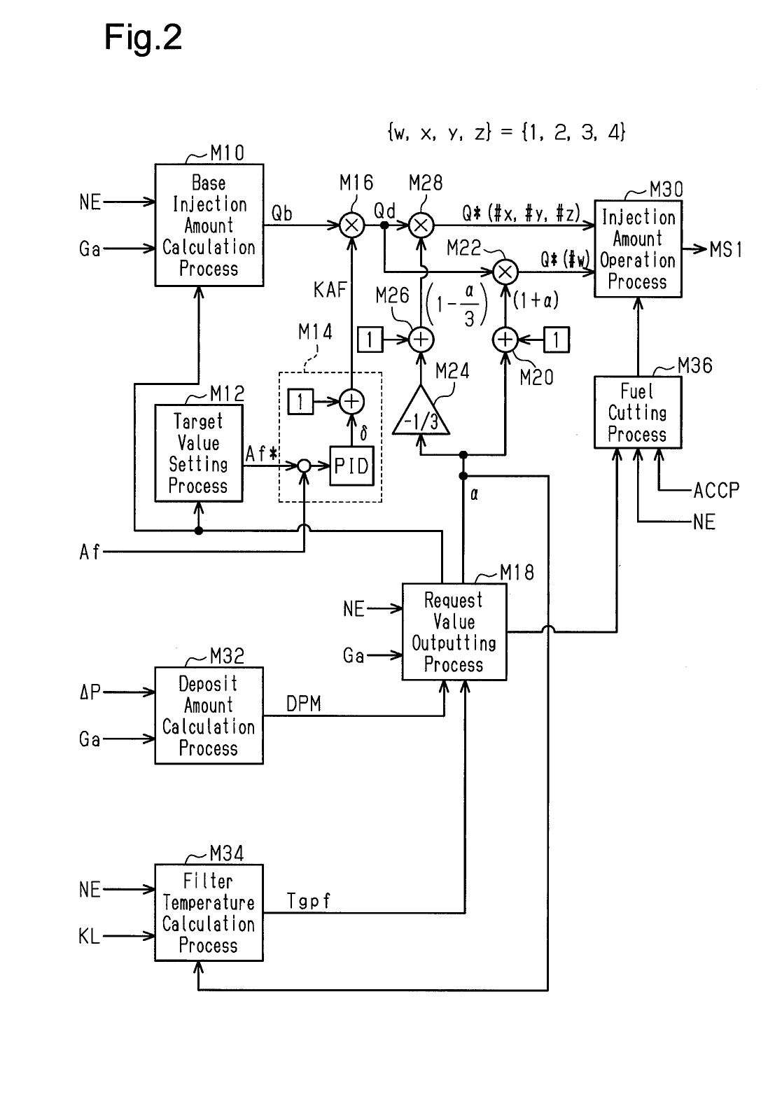

FIG. 2 shows some of the processes implemented by the CPU 32 running the programs stored in the ROM 34.

A base injection amount calculation process M10 calculates a base injection amount Qb as an open-loop operation amount, which is an operation amount for adjusting the air-fuel ratio of the mixture in the combustion chambers 16 to a target air-fuel ratio through open-loop control, based on a rotation speed NE calculated based on the output signal Scr of the crank angle sensor 46 and the intake air amount Ga.

A target value setting process M12 sets a target value Af* of a feedback control amount for controlling the air-fuel ratio of the mixture in the combustion chambers 16 to the target air-fuel ratio.

A feedback process M14 calculates a feedback operation amount KAF, which is an operation amount for adjusting the air-fuel ratio Af, that is, the feedback control amount, to the target value Af* through feedback control. In the present embodiment, the difference of the target value Af* and the air-fuel ratio Af is input to each of a proportional element, an integral element, and a differential element, and output values of the proportional element, the integral element, and the differential element are summed to calculate a correction factor δ of the base injection amount Qb. The feedback operation amount KAF is “1+δ.”

A request injection amount calculation process M16 corrects the base injection amount Qb by multiplying the base injection amount Qb by the feedback operation amount KAF to calculate a request injection amount Qd.

A request value outputting process M18 calculates and outputs an injection amount correction request value α of dither control. Dither control varies the air-fuel ratio of the mixture that is burned from one cylinder to another while controlling the injection amount so that the components of the entire exhaust discharged from the cylinders #1 to #4 of the internal combustion engine 10 are the same as those when the air-fuel ratio of the mixture that is burned is the target air-fuel ratio in all of the cylinders #1 to #4. The phrase “controlling the injection amount so that the components of the entire exhaust discharged from the cylinders #1 to #4 are the same as those when the air-fuel ratio of the mixture that is burned is the target air-fuel ratio in all of the cylinders #1 to #4” means that the injection amount is controlled so that the entire exhaust discharged from the cylinders #1 to #4 contains unburned fuel components and oxygen that react with each other without excess or deficiency. In dither control of the present embodiment, one of the first to fourth cylinders #1 to #4 is set to a rich combustion cylinder, the air-fuel ratio of which is richer than a stoichiometric air-fuel ratio, and the remaining three cylinders are set to a lean combustion cylinder, the air-fuel ratio of which is leaner than the stoichiometric air-fuel ratio. The injection amount of the rich combustion cylinder is set to be “1+α” times greater than the request injection amount Qd, and the injection amount of the lean combustion cylinder is set to be “1−(α/3)” times greater than the request injection amount Qd. With the setting of the injection amounts of the lean combustion cylinder and the rich combustion cylinder described above, if the cylinders #1 to #4 are filled with the same amount of air, the components of the entire exhaust discharged from the cylinders #1 to #4 of the internal combustion engine 10 are the same as those when the air-fuel ratio of the mixture that is burned is the target air-fuel ratio in all of the cylinders #1 to #4. with the setting of the injection amounts described above, if the cylinders #1 to #4 are filled with the same amount of air, the inverse of an average value of fuel-air ratios of mixtures that are burned in the cylinders #1 to #4 is the target air-fuel ratio. The fuel-air ratio is the inverse of the air-fuel ratio.

The setting of the inverse of the average value of the fuel-air ratios to the target air-fuel ratio aims to control exhaust components in a desirable manner. In the description hereafter, when unburned fuel components and oxygen in exhaust react with each other without excess or deficiency, the exhaust air-fuel ratio is referred to as the stoichiometric air-fuel ratio. When the amount of unburned fuel components in exhaust is more than that reacting with oxygen without excess or deficiency, the exhaust air-fuel ratio is referred to as rich. When the amount of unburned fuel components in exhaust is less than that reacting with oxygen without excess or deficiency, the exhaust air-fuel ratio is referred to as lean. When the amount of unburned fuel components in exhaust is less than that reacting with oxygen without excess or deficiency, the excess amount has a negative value. For example, the exhaust air-fuel ratio related to the entire exhaust discharged from the cylinders #1 to #4 is defined as the average value of exhaust air-fuel ratios per combustion cycle.

A correction coefficient calculation process M20 adds one to the injection amount correction request value α to calculate a correction coefficient of the request injection amount Qd for the rich combustion cylinder. A dither correction process M22 multiples the request injection amount Qd by the correction coefficient “1+α” to calculate an injection amount instruction value Q* of a cylinder # w corresponding to the rich combustion cylinder. Here, “w” represents one of “1” to “4.”

A multiplication process M24 multiplies the injection amount correction request value α by “−⅓.” A correction coefficient calculation process M26 adds one to the output value of the multiplication process M24 to calculate a correction coefficient of the request injection amount Qd for the lean combustion cylinder. A dither correction process M28 multiplies the request injection amount Qd by the correction coefficient “1−(α/3)” to calculate the injection amount instruction value Q* of cylinders # x, # y, and # z corresponding to the lean combustion cylinders. Here, each of “x,” “y,” and “z” is one of “1” to “4,” and “w,” “x,” “y,” and “z” differ from each other.

An injection amount operation process M30 generates an operating signal MS1 for the fuel injection valve 18 of the cylinder # w corresponding to the rich combustion cylinder based on the injection amount instruction value Q* output from the dither correction process M22 and sends the operating signal MS to the fuel injection valve 18 to operate the fuel injection valve 18 so that the amount of fuel injected from the fuel injection valve 18 corresponds to the injection amount instruction value Q*. The injection amount operation process M30 also generates an operating signal MS1 for the fuel injection valves 18 of the cylinders # x, # y, and # z corresponding to the lean combustion cylinders based on the injection amount instruction value Q* output from the dither correction process M28 and sends the operating signal MS1 to the fuel injection valves 18 to operate the fuel injection valves 18 so that the amount of fuel injected from the fuel injection valves 18 corresponds to the injection amount instruction value Q*.

A deposit amount calculation process M32 calculates and outputs the amount of PM captured by the GPF 26 (PM deposit amount DPM) based on the differential pressure ΔP and the intake air amount Ga. The deposit amount calculation process M32 calculates the PM deposit amount DPM to be a larger value when the differential pressure ΔP is high than when the differential pressure ΔP is low and a smaller value when the intake air amount Ga is large than when the intake air amount Ga is small. More specifically, the ROM 34 stores map data in which the differential pressure ΔP and the intake air amount Ga are input variables and the PM deposit amount DPM is an output variable, and the CPU 32 obtains the PM deposit amount DPM through map calculation. The map data is a data set of discrete values of an input variable and values of an output variable corresponding to each value of the input variable. For example, when the value of an input variable matches any value of the input variable in the map data, the map calculation may use the corresponding value of the output variable in the map data as a calculation result. When there is no match, the map calculation may use a value obtained by interpolating multiple values of the output variable contained in the map data as a calculation result.

A filter temperature calculation process M34 calculates the temperature of the GPF 26 (filter temperature Tgpf) based on the rotation speed NE, a load factor KL, and the injection amount correction request value α. More specifically, the filter temperature calculation process M34 calculates a base temperature Tb based on the rotation speed NE and the load factor KL and calculates an increase correction amount of the base temperature Tb based on the injection amount correction request value α to calculate the filter temperature Tgpf. The base temperature Tb is an estimated value of the temperature of the GPF 26 when dither control is not executed in a normal state in which variations in the operating point of the internal combustion engine 10 specified by the rotation speed NE and the load factor KL can be neglected. When dither control is executed, the temperature of exhaust at the downstream side of the three-way catalyst 24 is increased more than when dither control is not executed by heat of reaction of unburned fuel discharged from the rich combustion cylinder with oxygen discharged from the lean combustion cylinder in the three-way catalyst 24. When the injection amount correction request value α is large, dither control causes the temperature of exhaust at the downstream side of the three-way catalyst 24 to increase by a greater amount than when the injection amount correction request value α is small. The base temperature Tb is corrected by being increased in accordance with the injection amount correction request value α to calculate the filter temperature Tgpf. More specifically, the ROM 34 stores map data in which the rotation speed NE and the load factor KL are input variables and the base temperature Tb is an output variable, and the CPU 32 obtains the base temperature Tb through map calculation. Also, the ROM 34 stores map data in which the injection amount correction request value α is an input variable and a temperature increase amount is an output variable, and the CPU 32 obtains the temperature increase amount through map calculation. The filter temperature Tgpf is calculated so that the filter temperature Tgpf approaches an amount obtained by adding the temperature increase amount to the base temperature Tb as time elapses. More specifically, the CPU 32 calculates the filter temperature Tgpf by performing an exponential moving average process on the amount obtained by adding the temperature increase amount to the base temperature Tb and the filter temperature Tgpf.

The load factor KL is a parameter indicating the amount of air filling the combustion chambers 16 and is calculated by the CPU 32 based on the intake air amount Ga. The load factor KL is the ratio of an amount of air flowing into a cylinder per combustion cycle to a reference inflow air amount. The reference inflow air amount may be variably set in accordance with the rotation speed NE.

A fuel cutting process M36 stops the fuel injection under a condition in which the accelerator operation amount ACCP determines that the accelerator pedal 50 is released and the rotation speed NE is within a predetermined range.

A request value outputting process M18 sets the injection amount correction request value α to be a value greater than zero in accordance with the PM deposit amount DPM for the regeneration process of the GPF 26 (filter regeneration process).

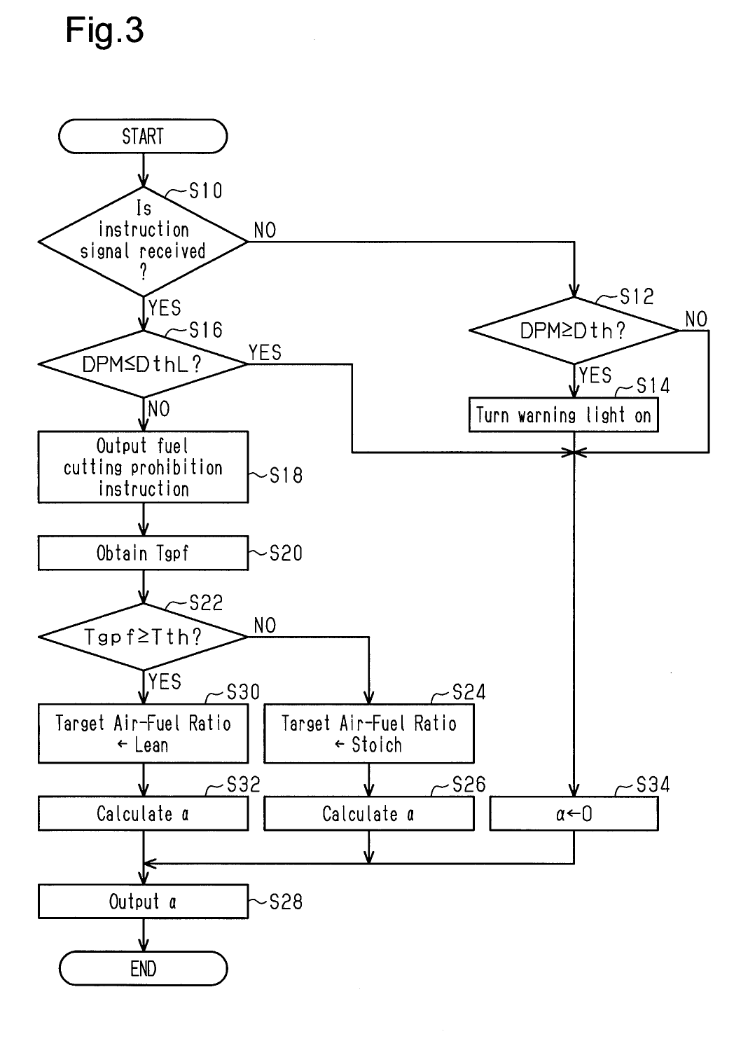

FIG. 3 shows the procedures of the request value outputting process M18. The process shown in FIG. 3 is implemented by the CPU 32 by, for example, repeatedly running a program stored in the ROM 34 in predetermined cycles. Hereafter, numerals with “S” provided in front represent step numbers.

In the series of processes shown in FIG. 3, the CPU 32 determines whether or not the controller 30 receives an execution instruction signal of the filter regeneration process from outside the controller 30 to service the GPF 26 (S10). The instruction signal is assumed to be a signal input by staff of a service shop to the controller 30 from a dedicated problem-handling device (maintenance device) connected to the controller 30. More specifically, the process of S10 determines whether it is time for staff of the service shop to take over the vehicle from the user and perform the filter regeneration process.

If the CPU 32 determines that the instruction signal is not input to the controller 30 (S10: NO), the CPU 32 determines whether or not the PM deposit amount DPM is greater than or equal to a specified amount Dth (S12). When the PM deposit amount DPM is greater than or equal to the specified amount Dth, the PM deposit amount DPM is significantly large. This means that if the PM deposit amount DPM is left untreated, the internal combustion engine 10 may have trouble in running. If the CPU 32 determines that the PM deposit amount DPM is greater than or equal to the specified amount Dth (S12: YES), the CPU 32 operates a warning light 54 shown in FIG. 1 to execute a process for prompting the user of the vehicle on which the internal combustion engine 10 is mounted to have the filter regeneration process performed at a service shop because the PM deposit amount DPM is large (S14).

If the CPU 32 determines that the instruction signal is input to the controller 30 (S10: YES), the CPU 32 determines whether or not the PM deposit amount DPM is less than or equal to a predetermined amount DthL that is smaller than the specified amount Dth (S16). If the CPU 32 determines that the PM deposit amount DPM is greater than the predetermined amount DthL (S16: NO), the CPU 32 outputs a fuel cutting prohibition instruction (S18). As a result, in the fuel cutting process M36, the process for stopping the fuel injection will not be executed even when the execution condition described above is satisfied. Then, the CPU 32 obtains the filter temperature Tgpf (S20). The CPU 32 determines whether or not the filter temperature Tgpf is greater than or equal to a specified temperature Tth (S22). When the filter temperature Tgpf is greater than or equal to the specified temperature Tth, particulate matter captured by the GPF 26 is burnable with the supply of oxygen to the GPF 26. The specified temperature Tth is set to, for example, a temperature of 550° C. or higher.

If the CPU 32 determines that the filter temperature Tgpf is less than the specified temperature Tth (S22: NO), the CPU 32 sets the target air-fuel ratio to a stoichiometric air-fuel ratio (stoich) (S24). This setting is for controlling an average value of exhaust air-fuel ratios per combustion cycle to the stoichiometric air-fuel ratio. The CPU 32 calculates the injection amount correction request value α based on the operating point of the internal combustion engine 10 specified by the rotation speed NE and the load factor KL (S26) and outputs the injection amount correction request value α (S28). If the CPU 32 determines that the filter temperature Tgpf is greater than or equal to the specified temperature Tth (S22: YES), the CPU 32 sets the target air-fuel ratio to be leaner than the stoichiometric air-fuel ratio (S30). This setting is for controlling an average value of exhaust air-fuel ratios per combustion cycle to be leaner than the stoichiometric air-fuel ratio so that oxygen is supplied to the GPF 26. The CPU 32 calculates the injection amount correction request value α based on the operating point of the internal combustion engine 10 specified by the rotation speed NE and the load factor KL (S32) and outputs the injection amount correction request value α (S28).

In the processes of S26 and S32, the CPU 32 may set the injection amount correction request value α to zero depending on the operating point of the internal combustion engine 10. This is because depending on the operating point, if the exhaust temperature is low when dither control is not executed, it is difficult for dither control to increase the temperature of the GPF 26 to the specified temperature Tth or higher. When the injection amount correction request value α is greater than zero, the injection amount correction request value α that is calculated by the process of S26 is set to a greater value than the injection amount correction request value α that is calculated by the process of S32. This is because as compared to when the target air-fuel ratio is leaner than the stoichiometric air-fuel ratio, when the target air-fuel ratio is the stoichiometric air-fuel ratio, a combustion limit is not easily reached even if the air-fuel ratio of the lean combustion cylinder is set to be leaner than the target air-fuel ratio. When the injection amount correction request value α has a value greater than zero, the injection amount correction request value α that is calculated by the process of S26 is set to various values in accordance with the rotation speed NE and the load factor KL. In the same manner, when the injection amount correction request value α has a value greater than zero, the injection amount correction request value α that is calculated by the process of S32 is set to various values in accordance with the rotation speed NE and the load factor KL.

When the process of S14 is completed, the negative determination is made in the process of S12, or the affirmative determination is made in the process of S16, the CPU 32 assigns zero to the injection amount correction request value α (S34) and proceeds to the process of S28. When the process of S28 is completed, the CPU 32 temporarily ends the series of processes shown in FIG. 3.

The operation and advantages of the present embodiment will now be described.

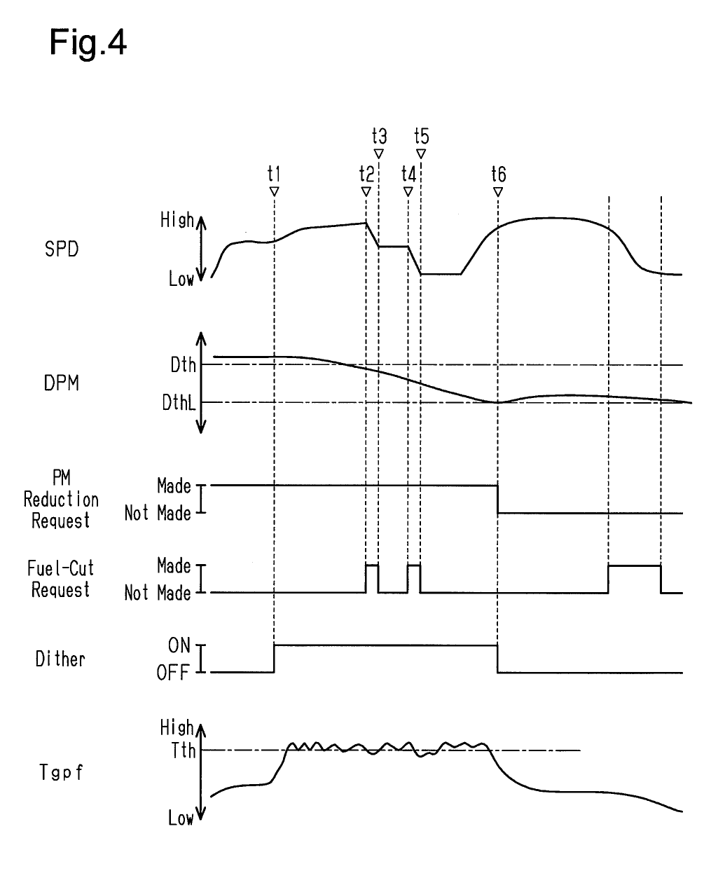

In FIG. 4, it is assumed that before time t1, the PM deposit amount DPM is greater than or equal to the specified amount Dth, a request of the filter regeneration process (PM reduction request) is made, and the controller 30 is connected to the maintenance device at a service shop.

At time t1, when injection amount correction request value α that is calculated in accordance with the operating point of the internal combustion engine 10 becomes greater than zero and dither control is executed, the filter temperature Tgpf is increased to the specified temperature Tth or higher. Accordingly, the CPU 32 sets the target air-fuel ratio to be lean and continues dither control while supplying oxygen to the GPF 26. This avoids a situation in which the filter temperature Tgpf extremely decreases. Further, FIG. 4 shows that a process setting the target air-fuel ratio to the stoichiometric air-fuel ratio when the filter temperature Tgpf becomes less than the specified temperature Tth and a process setting the target air-fuel ratio to be lean when the filter temperature Tgpf becomes greater than or equal to the specified temperature Tth are executed multiple times.

While the filter regeneration process is executed, a condition for executing the fuel cutting process determined by the accelerator operation amount ACCP and the rotation speed NE is satisfied in times t2 to t3 and t4 to t5. However, the CPU 32 does not execute the fuel cutting process. This sufficiently avoids a situation in which the filter temperature Tgpf excessively decreases. At time t6, the PM deposit amount DPM becomes less than or equal to the predetermined amount DthL, and the CPU 32 stops dither control.

The present embodiment further obtains the advantages described below.

(1) Dither control is executed under a condition in which the execution instruction signal of the filter regeneration process is input to the controller 30 to service the GPF 26. Thus, an average value of exhaust air-fuel ratios is easily controlled to be leaner than the stoichiometric air-fuel ratio as compared to normal operation performed by the user. Additionally, increases in variations of rotation of the crankshaft are easily allowed. This particularly allows for increases in the injection amount correction request value α that is calculated by the process of S26.

(2) When the PM deposit amount DPM is greater than or equal to the specified amount Dth, the warning light 54 is turned on. This prompts the user to have service at a service shop.

### Correspondence Relationship

The correspondence relationship between the description of the above embodiment and the description in the section of “SUMMARY” is as follows. In the description below, the correspondence relationship is described for each numeral of problem solving means described in the section of “SUMMARY.”

[1] The filter corresponds to the GPF 26. The dither control process corresponds to the correction coefficient calculation process M20, the dither correction process M22, the multiplication process M24, the correction coefficient calculation process M26, the dither correction process M28, and the injection amount operation process M30 when the injection amount correction request value α is greater than zero. The prohibition process corresponds to the process of S18.

[2] The prohibition process corresponds to the process of S18 when the processes of S24 and S26 are executed.

[3] The second period corresponds to the period of one combustion cycle. The process setting the target air-fuel ratio to be lean corresponds to the process of S30.

[4] Executing the dither control process when the execution instruction signal of the filter regeneration process is input to the controller corresponds to the process of S10.

[5] The notification process corresponds to the process of S14.

### Other Embodiments

The present embodiment may be modified as follows. The present embodiment and the modified examples may be combined within a range where technical contradiction does not occur.

### Prohibition Process

In the above embodiment, when the PM deposit amount DPM is greater than the predetermined amount DthL, the fuel cutting process is prohibited regardless of whether or not the filter temperature Tgpf is greater than or equal to the specified temperature Tth. Instead, for example, when the filter temperature Tgpf continues to be greater than or equal to the specified temperature Tth for a predetermined time, the fuel cutting process may be executed. In this case, particulate matter can be burned by oxygen supplied to the GPF 26 by the fuel cutting process.

For example, as described below in the section of “Dither Control Process Corresponding to Regeneration Process Execution Request,” when dither control is executed while the user is driving, the fuel cutting process may be prohibited under a condition in which the filter temperature Tgpf is less than the specified temperature Tth. In this case, when the filter temperature Tgpf is greater than or equal to the specified temperature Tth and the execution condition of the fuel cutting process described above is satisfied, dither control may be stopped by executing the fuel cutting process. This allows oxygen to be supplied to the GPF 26 to burn the particulate matter.

### Execution Instruction Signal for Service

In the above embodiment, a maintenance device is connected to the controller 30, and the execution instruction signal is input to the controller 30 from the maintenance device. Instead, for example, the input of the execution instruction signal of the regeneration process may be a predetermined operation that cannot be expected from normal operations performed by the user such as simultaneous depression on the accelerator pedal and the brake pedal when the shift lever is in the neutral position.

### PM Deposit Amount

In the above embodiment, the PM deposit amount DPM is obtained based on the differential pressure ΔP and the intake air amount Ga through map calculation. Instead, for example, when the intake air amount Ga is greater than or equal to a specified value, the above map calculation may be performed to obtain the PM deposit amount DPM. When the intake air amount Ga is less than the specified value, the PM deposit amount DPM may be estimated based on the rotation speed NE, the load factor KL, the temperature (water temperature THW) of the coolant in the internal combustion engine 10, and the air-fuel ratio Af. This may be performed, for example, as follows. That is, the ROM 34 stores map data in which the rotation speed NE and the load factor KL are input variables and a PM deposit increase amount per unit time is an output variable, map data in which the water temperature THW is an input variable and a water temperature correction coefficient is an output variable, and map data in which the air-fuel ratio Af is an input variable and an air-fuel ratio correction coefficient is an output variable. After the CPU 32 obtains each of the PM deposition increase amount, the water temperature correction coefficient, and the air-fuel ratio correction coefficient through map calculation, the PM deposition increase amount is multiplied by the water temperature correction coefficient and the air-fuel ratio correction coefficient so that the PM deposition increase amount is corrected, and the corrected PM deposition increase amount is used to successively perform increase correction on the PM deposit amount DPM. When the intake air amount Ga is shifted from greater than or equal to the specified value to less than the specified value, the initial value of the PM deposit amount DPM may be calculated based on the differential pressure ΔP described above. When the intake air amount Ga is shifted from less than the specified value to greater than or equal to the specified value, the PM deposit amount DPM may be calculated based on the differential pressure ΔP and used.

Alternatively, instead of being based on the differential pressure ΔP, under a condition in which the filter temperature Tgpf is less than the specified temperature Tth, the PM deposit amount DPM may be estimated by successively accumulating the PM deposition increase amount, which is corrected by the water temperature correction coefficient and the air-fuel ratio correction coefficient. In this case, when the filter temperature Tgpf is greater than or equal to the specified temperature Tth, if oxygen is supplied to the GPF 26, decrease correction may be performed on the PM deposit amount DPM. This may be achieved by successively calculating a decrease correction amount in accordance with the filter temperature Tgpf and the PM deposit amount DPM and performing the decrease correction on the PM deposit amount using the decrease correction amount. It is desirable that the decrease correction amount be larger when the filter temperature Tgpf is high than when the filter temperature Tgpf is low and that the decrease correction amount be larger when the PM deposit amount DPM is large than when the PM deposit amount DPM is small. This may be achieved by storing map data in which the filter temperature Tgpf and the PM deposit amount DPM are input variables and the decrease correction amount is an output variable in the ROM 34 and having the CPU 32 obtain the decrease correction amount through map calculation.

Further, a dedicated sensor may be used to detect the PM deposit amount DPM.

### Filter Temperature

In the above embodiment, the estimated filter temperature Tgpf is obtained and used. Instead, for example, the GPF 26 may include a temperature sensor such as a thermocouple, and its detection value may be obtained.

### Filter Regeneration Process

In the above embodiment, the target air-fuel ratio is changed from rich to lean or from lean to rich across the border of the specified temperature Tth. Instead, the filter temperature Tgpf at which the target air-fuel ratio is changed from rich to lean may differ from the filter temperature Tgpf at which the target air-fuel ratio is changed from lean to rich.

In the above embodiment, the target air-fuel ratio is switched in accordance with the filter temperature Tgpf. Instead, for example, the target air-fuel ratio may constantly be set to be leaner than the stoichiometric air-fuel ratio so that the process for switching the target air-fuel ratio does not have to be executed.

For example, as described below in the section of “Dither Control Process Corresponding to Regeneration Process Execution Request,” when dither control is executed while the user is driving, it is desirable that the target air-fuel ratio constantly be the stoichiometric air-fuel ratio.

### Dither Control Process Corresponding to Regeneration Process Execution Request

In the above embodiment, under a condition in which staff of a service shop inputs the execution instruction signal to the controller 30, the filter regeneration process is executed. Instead, the filter regeneration process may be executed, for example, when the PM deposit amount DPM is greater than or equal to a predetermined amount that is smaller than the specified amount Dth and the internal combustion engine 10 runs at a high load, by executing the dither control process with the injection amount correction request value α set to a smaller value than that of the above embodiment.

### Dither Control Process

In the above embodiment, the injection amount correction request value α is calculated from the two parameters of the rotation speed NE and the load factor KL. Instead, for example, the injection amount correction request value α may be calculated based on the water temperature THW in addition to the rotation speed NE and the load factor KL. The injection amount correction request value α may be calculated based on the PM deposit amount DPM. Moreover, the injection amount correction request value α does not necessarily have to be calculated based on the rotation speed NE and the load factor KL. For example, the injection amount correction request value α may be variably set based on at least one of the four parameters of the PM deposit amount DPM, the water temperature THW, the rotation speed NE, and the load factor KL. For example, instead of using the rotation speed NE and the load factor KL as parameters specifying the operating point of the internal combustion engine 10, the accelerator operation amount as a load may be used instead of the load factor KL as a load. Instead of the rotation speed NE and the load, the injection amount correction request value α may be variably set based on the intake air amount Ga.

It is not necessary to variably set the injection amount correction request value α to a value greater than zero at an operating point where dither control is executed. For example, at the operating point where dither control is executed, a single value greater than zero may be set for each of the processes of S26 and S32.

In the above embodiment, the number of lean combustion cylinders is greater than the number of rich combustion cylinders. Instead, for example, the number of rich combustion cylinders and the number of lean combustion cylinders may be the same. Additionally, for example, instead of setting all of the cylinders #1 to #4 to either a lean combustion cylinder or a rich combustion cylinder, for example, the air-fuel ratio of one of the cylinders may be set to the target air-fuel ratio. Still additionally, if the amount of air filling the cylinders is the same in one combustion cycle, the inverse of an average value of fuel-air ratios does not necessarily have to be the target air-fuel ratio. For example, when four cylinders are provided as in the above embodiment, the inverse of an average value of fuel-air ratios in five strokes may be controlled to the target air-fuel ratio if the amount of air filling the cylinders is the same. Alternatively, the inverse of an average value of fuel-air ratios in three strokes may be controlled to the target air-fuel ratio. In this case, it is desirable that a period during which both a rich combustion cylinder and a lean combustion cylinder exist in one combustion cycle be generated one time or more in at least two combustion cycles. In other words, if the amount of air filling the cylinders is the same during a predetermined period when the inverse of an average value of fuel-air ratios is controlled to the target air-fuel ratio, it is desirable that the predetermined period be set to two combustion cycles or less. For example, when the predetermined period is two combustion cycles and a rich combustion cylinder exists only one time during two combustion cycles, the appearance order of a rich combustion cylinder and a lean combustion cylinder is expressed as, for example, “R, L, L, L, L, L, L, L” where R denotes a rich combustion cylinder, and L denotes a lean combustion cylinder. In this case, the order “R, L, L, L” appears in a period of one combustion cycle, which is shorter than the predetermined period. Thus, at least one of the cylinders #1 to #4 is a lean combustion cylinder, and at least a further one of the cylinders is a rich combustion cylinder. If the inverse of an average value of fuel-air ratios is controlled to the target air-fuel ratio in a period differing from one combustion cycle, it is desirable that the amount of air that is temporarily drawn by the internal combustion engine in an air intake step and then returns to the intake air passage before the intake valve is closed can be neglected.

### Exhaust Purifying Device

In the above embodiment, the upstream exhaust purifying device is the three-way catalyst 24, and the downstream exhaust purifying device is the GPF 26. Instead, for example, the upstream exhaust purifying device may be a GPF, and the downstream exhaust purifying device may be a three-way catalyst. In the above configuration, the three-way catalyst 24 and the GPF 26 are described as examples of exhaust purifying devices. Instead, for example, the exhaust purifying device may include only the GPF 26. However, when a catalyst capable of storing oxygen is not provided at the upstream side of the GPF, it is desirable that the GPF be capable of storing oxygen to improve the temperature increase performance of dither control.

### Controller

The controller is not limited to that including the CPU 32 and the ROM 34 and executing software processes. For example, a dedicated hardware circuit (e.g., ASIC) may be included to execute at least some of the software processes executed in the above embodiment. More specifically, the controller only needs to have any one of configurations (a) to (c) described below. Configuration (a) includes a processor executing all of the processes described above in accordance with programs and a program storage device storing the programs such as a ROM. Configuration (b) includes a processor executing some of the processes described above in accordance with programs, a program storage device, and a dedicated hardware circuit executing the remaining processes. Configuration (c) includes a dedicated hardware circuit executing all of the processes described above. Multiple software circuits including a processor and a program storage device and multiple dedicated hardware circuits may be included. More specifically, the processes described above only need to be executed by processing circuitry including at least one of one or more software circuits and one or more dedicated hardware circuits. The program storage device, or a computer readable medium, includes any available media accessible with a versatile or dedicated computer.

### Internal Combustion Engine

The internal combustion engine is not limited to a four-cylinder internal combustion engine. The internal combustion engine may be, for example, a straight-six-cylinder internal combustion engine. The internal combustion engine may be of, for example, V-type. In this case, the internal combustion engine may include a first exhaust purifying device and a second exhaust purifying device, and the first exhaust purifying device and the second exhaust purifying device may purify exhaust discharged from different cylinders.

### Notification Device

The notification device is not limited to the warning light 54 and may be, for example, a device outputting a sound signal.

### Others

The fuel infection valves are not limited to those injecting fuel into the combustion chambers 16 and may be, for example, fuel injection valves injecting fuel into the intake passage 12. It is not necessary to execute air-fuel ratio feedback control during execution of dither control.

Therefore, the present examples and embodiments are to be considered as illustrative and not restrictive and the invention is not to be limited to the details given herein, but may be modified within the scope and equivalence of the appended claims.

1. A controller for an internal combustion engine mounted on a vehicle, wherein the internal combustion engine includes a filter configured to capture particulate matter in exhaust discharged from a plurality of cylinders and a plurality of fuel injection valves respectively arranged for the plurality of cylinders, the controller comprising processing circuitry, wherein the processing circuitry is configured to execute:
a dither control process operating the fuel injection valves so that at least one of the plurality of cylinders is a lean combustion cylinder having an air-fuel ratio that is leaner than a stoichiometric air-fuel ratio and at least a further one of the plurality of cylinders is a rich combustion cylinder having an air-fuel ratio that is richer than the stoichiometric air-fuel ratio under a condition in which a request for executing a regeneration process of the filter is made;
a fuel cutting process stopping fuel injection performed by the fuel injection valves under a condition in which an accelerator operation amount is zero; and
a prohibition process prohibiting the fuel cutting process under a condition in which the dither control process is executed.

2. The controller for an internal combustion engine according to claim 1, wherein
the prohibition process includes a process prohibiting the fuel cutting process when the dither control process is executed and a temperature of the filter is increased from below a required temperature toward the required temperature, and
the required temperature is a temperature required by the regeneration process.

3. The controller for an internal combustion engine according to claim 2 wherein
the dither control process includes
controlling the air-fuel ratio of each cylinder in a first period so that at least one of the plurality of cylinders is the lean combustion cylinder, in which the air-fuel ratio is leaner than the stoichiometric air-fuel ratio, and at least a further one of the plurality of cylinders is the rich combustion cylinder, in which the air-fuel ratio is richer than the stoichiometric air-fuel ratio,
controlling an average value of exhaust air-fuel ratios to a target air-fuel ratio in a second period including the first period, and
under a condition in which the temperature of the filter reaches the required temperature, setting the target air-fuel ratio to be leaner than before the temperature of the filter reaches the required temperature, and
the prohibition process includes a process prohibiting the fuel cutting process when the target air-fuel ratio is set to be lean after the temperature of the filter reaches the required temperature.

4. The controller for an internal combustion engine according to claim 1, wherein the processing circuitry is configured to execute the dither control process when an execution instruction signal of a regeneration process of the filter is input to the controller from outside the controller to service the filter.

5. The controller for an internal combustion engine according to claim 4, wherein the processing circuitry is configured to execute a notification process providing notification for a user by operating a notification device when an amount of the particulate matter is greater than or equal to a specified amount.

6. A method for controlling an internal combustion engine mounted on a vehicle, wherein the internal combustion engine includes a filter configured to capture particulate matter in exhaust discharged from a plurality of cylinders and a plurality of fuel injection valves respectively arranged for the plurality of cylinders, the method comprising:
executing a dither control process operating the fuel injection valves so that at least one of the plurality of cylinders is a lean combustion cylinder having an air-fuel ratio that is leaner than a stoichiometric air-fuel ratio and at least a further one of the plurality of cylinders is a rich combustion cylinder having an air-fuel ratio that is richer than the stoichiometric air-fuel ratio under a condition in which a request for executing a regeneration process of the filter is made;
executing a fuel cutting process stopping fuel injection performed by the fuel injection valves under a condition in which an accelerator operation amount is zero; and
executing a prohibition process prohibiting the fuel cutting process under a condition in which the dither control process is executed.
